(19) United States
(12) Patent Application Publication
(10) Pub. No.: US 2025/0384530 A1
(43) Pub. Date: Dec. 18, 2025

(54) ITERATIVE SPECULARITY FACTORIZATION FOR IMAGE ENHANCEMENT

(71) Applicant: International Institute of Information Technology, Hyderabad, Hyderabad (IN)

(72) Inventors: P.J. Narayanan, Hyderabad (IN); Saurabh Saini, Hyderabad (IN)

(21) Appl. No.: 19/236,243

(22) Filed: Jun. 12, 2025

(30) Foreign Application Priority Data
Jun. 12, 2024 (IN) 202441045465

(51) Int. Cl. G06T 5/60; G06T 5/70

(52) U.S. Cl. CPC G06T 5/60; G06T 5/70; G06T 2207/20081; G06T 2207/20084

(57) ABSTRACT

Disclosed herein is a method for image enhancement. The method begins by receiving an input image, which is then decomposed into a plurality of K additive factors using a factorization network. The decomposition process involves iteratively performing an L₁ optimization for K iterations, configured to approximate image specularity or highlights as matrix sparsity. A crucial aspect is the progressive relaxation of a sparsity constraint associated with the L₁ optimization for each successive iteration, allowing for the extraction of increasingly less sparse additive factors. The factorization network utilizes learned parameters, such as thresholds, shrinkage values, or step sizes, for this optimization. Finally, an enhanced output image is generated by fusing the K additive factors through a fusion network.

### BACKGROUND

### Technical Field

The present disclosure relates generally to digital image processing techniques. More particularly, the present disclosure relates to methods and systems for image enhancement that employ iterative factorization of an image into a plurality of additive components based on estimations of specularity or image highlights approximated as matrix sparsity, utilizing learned parameters within a factorization network, and subsequent fusion of these components to generate an enhanced image.

### Description of Related Art

Digital image processing plays a crucial role in numerous applications, with image enhancement being a significant area of focus. Images captured in real-world scenarios often suffer from various degradations due to undesirable artifacts such as highlights, reflections, and shadows. The ability to effectively separate and manipulate these additive components from the underlying image content can substantially improve perceptual quality and unlock advanced image editing capabilities.

Traditional approaches aimed at separating such additive components have often relied on methods like sparse coding or dictionary learning. These methods seek to represent images as a linear combination of basic functions or atoms. However, the efficacy of separation in these techniques heavily depends on the chosen basis and the degree of sparsity imposed during the optimization process. Consequently, these methods face inherent limitations in effectively distinguishing and extracting different types of additive elements like highlights and reflections from image data.

More recent techniques have attempted to overcome these limitations by integrating sparse representations within optimization frameworks specifically designed for separating highlights or reflections. Such methods typically extract a sparse component, representing the highlights and reflections, by solving an optimization problem that encourages sparsity, for example, by minimizing the L₁ norm of the component. Nevertheless, these approaches often require meticulous tuning of sparsity parameters and may not fully exploit the complex interdependencies between different additive components present in natural images.

Other conventional methodologies have explored incorporating sparse coding models within deep learning architectures to learn the separation process in a data-driven manner. While these deep learning-based methods leverage the powerful representational capabilities of neural networks, they frequently operate as end-to-end “black-box” systems. This often means they do not explicitly factorize the image into its constituent additive components, such as diffuse and specular layers, during the training or separation process. This lack of explicit factorization can limit their ability to capture and model the intricate relationships between these different image components.

Furthermore, existing image enhancement solutions, particularly in areas like Low-Light Enhancement (LLE), can be categorized based on their training paradigms, each with its own set of challenges. For instance, supervised LLE methods typically require paired ground truth images for training, which can be difficult to obtain. Unsupervised LLE approaches may still need unpaired ground truth data collections. While zero-reference and self-supervised methods aim to alleviate these data requirements, existing solutions may still face limitations in terms of absolute performance, model size, generalization across diverse datasets, interpretability of the enhancement process, degree of user control, and applicability across multiple enhancement tasks.

Therefore, there is a continuing need in the field for improved image processing methods that can robustly and interpretably decompose real-world images into semantically meaningful additive factors, addressing the aforementioned technical drawbacks in existing technologies and providing enhanced flexibility and performance across various image enhancement applications.

### SUMMARY

The present disclosure relates generally to image enhancement, and more particularly, the present disclosure relates to a method, system, and computer program for enhancing images through iterative specularity-based factorization and subsequent fusion of derived image components.

It is an object of the present disclosure to provide an improved image enhancement method and system. Moreover, the present disclosure relates to a method and system for decomposing an input image into a plurality of additive factors using a factorization network that employs an iterative optimization process with progressively relaxed sparsity constraints and learned parameters. Further, the present disclosure relates to a computer program that includes instructions for carrying out the method, when the computer program is executed on a computer system.

This object is achieved by the features of the independent claims. Further, implementation forms are apparent from the dependent claims, the description, and the figures.

According to a first aspect, there is provided a method for enhancing an image. The method includes receiving an input image. The method includes decomposing, via a factorization network, the input image into a plurality of K additive factors. This decomposing step comprises iteratively performing an optimization process for a predetermined number of K iterations to estimate a respective additive factor in each iteration, wherein the optimization process is configured to approximate image specularity or highlights as matrix sparsity using an L₁ optimization objective. The decomposing step further comprises progressively relaxing a sparsity constraint associated with the L₁ optimization objective for each successive iteration to enable the extraction of increasingly less sparse additive factors. Additionally, the decomposing step involves utilizing learned parameters within the factorization network, these learned parameters comprising at least one of thresholds, shrinkage values, or step sizes for the optimization process. The method concludes with generating an enhanced output image by fusing the plurality of K additive factors using a fusion network.

Preferably, the factorization network comprises a plurality of network layers formed by unrolling the steps of the optimization process into said network layers.

Preferably, the decomposing further comprises utilizing a factorization loss function during a training phase of the factorization network to guide the estimation of the plurality of K additive factors, wherein the factorization loss function constrains a ratio of signal energy in each k^{th} factor compared to an input for that k^{th} factor iteration to a predetermined value. More preferably, this factorization loss function enables zero-reference training of the factorization network.

Preferably, progressively relaxing the sparsity constraint comprises adjusting a hyperparameter that controls an amount of sparsity in a solution of the L₁ optimization objective for each of the K iterations.

Preferably, the fusion network is configured to enhance and denoise the K additive factors during the fusing process. Optionally, the fusion network utilizes a task-dependent pre-existing network architecture adapted for a specific image enhancement task selected from the group consisting of low-light enhancement, deraining, dehazing, and deblurring.

Preferably, the method further comprises pre-processing the K additive factors before the fusing by calculating difference factors F^{k}=E^{k}−E^{k-1}, where E is the k^{th} additive factor, and F¹=E¹.

According to a second aspect, there is provided a system comprising a processor and a memory storing instructions that, when executed by the processor, configure the system for carrying out all the steps of the above-described method.

According to a third aspect, there is provided a computer program including instructions for carrying out all the steps of the above-described method, when said computer program is executed on a computer system.

The method, system, and computer program described herein provide several benefits due to their design and technical principles, overcoming limitations in existing image enhancement techniques.

The described approach offers improved image enhancement, particularly in challenging scenarios such as low-light conditions, by effectively decomposing images into meaningful components. The iterative factorization with progressive sparsity relaxation allows for a nuanced separation of image layers corresponding to different illumination characteristics. The model-driven factorization network, which learns only a few key parameters by unrolling optimization steps, results in a lightweight and efficient system.

A key advantage is the capability for zero-reference training for certain tasks, such as low-light enhancement, as enabled by the novel factorization loss function. This alleviates the need for paired or even unpaired ground truth datasets, which are often difficult and expensive to acquire, thereby simplifying the training process and improving adaptability. The system demonstrates strong generalization performance across various datasets and image degradation types.

Furthermore, the generated factors are interpretable by design, representing distinct specular or illumination layers. This interpretability not only aids in understanding the enhancement process but also allows for user controllability, where users can potentially manipulate these factors for creative image editing. The modular nature, separating factorization from fusion, allows the derived factors to be used as a plug-and-play prior for various supervised image enhancement tasks like dehazing, deraining, and deblurring, showcasing multi-domain and multi-task generalizability with negligible overhead when combined with task-specific fusion networks.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein, and the embodiments herein include all such modifications.

### BRIEF DESCRIPTION OF DRAWINGS AND TABLES

Implementations of the disclosure will now be described, by way of example only, with reference to the accompanying drawings, in which:

FIG. 1 is a block diagram illustrating an overview of an exemplary image enhancement system;

FIG. 2 is a more detailed block diagram depicting an exemplary architecture and iterative process of a factorization network;

FIG. 3 is a flowchart illustrating the steps of an exemplary method for image enhancement;

FIG. 4 provides a qualitative comparison, illustrating visual results of the disclosed image enhancement method alongside outputs from other existing solutions on example low-light images;

FIG. 5 depicts a polar plot graphically summarizing the average performance scores of the disclosed method against other methods across multiple evaluation metrics and datasets;

FIG. 6 illustrates an ablation analysis, showing the effect of varying the number of factorization factors (K) on image enhancement performance metrics;

FIG. 7 showcases qualitative results of applying the disclosed specular factors as inputs to an existing base model for various image enhancement tasks, including dehazing, detraining, and deblurring;

FIG. 8 demonstrates controllable image relighting applications, showing how the disclosed factors can be used as layers to edit light specularity, indoor color, and outdoor intensity; and

FIG. 9 is a block diagram illustrating the computer system architecture for implementing the Kashmiri speech translation system.

### DETAILED DESCRIPTION

Implementations of the present disclosure provide a system and method for image enhancement using iterative specularity-based factorization and subsequent fusion of derived image components, implemented within a data processing system. This enables improved perceptual quality, advanced image editing capabilities, and application to tasks such as low-light enhancement, deraining, dehazing, and deblurring. Moreover, the present disclosure relates to a system for performing image processing through the decomposition of an input image into a plurality of additive factors, where said factors are based on approximations of image specularity or highlights as matrix sparsity. Further, the present disclosure relates to a computer program that includes instructions for carrying out the image enhancement method, when said computer program is executed on a computer system.

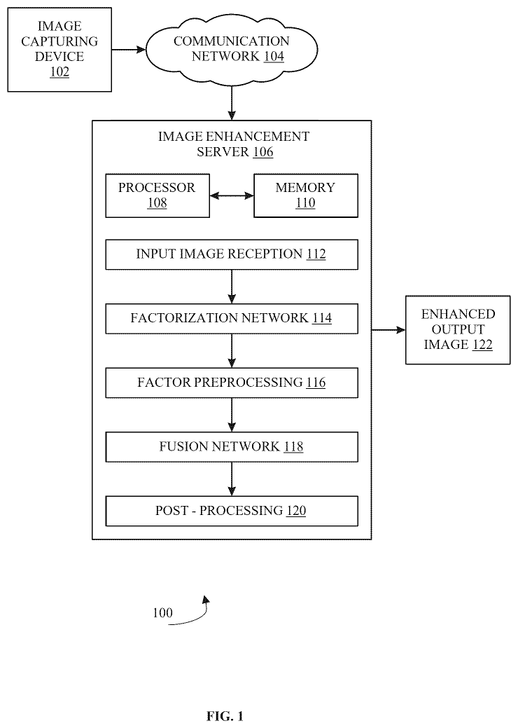

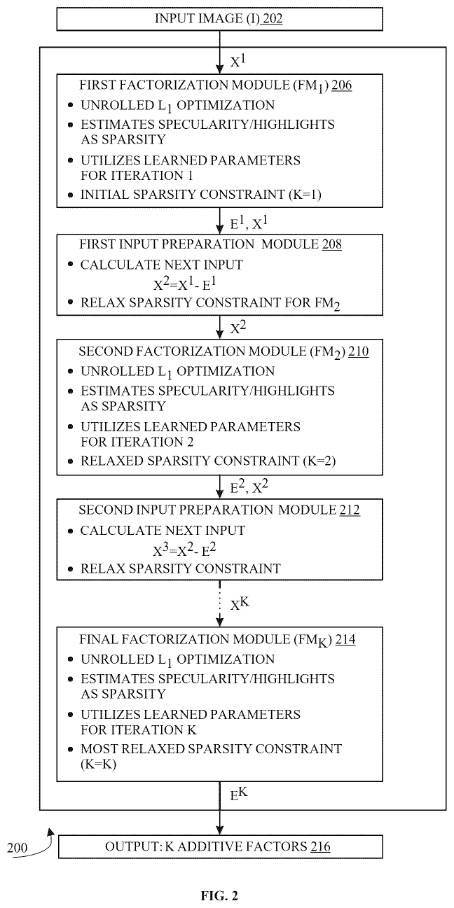

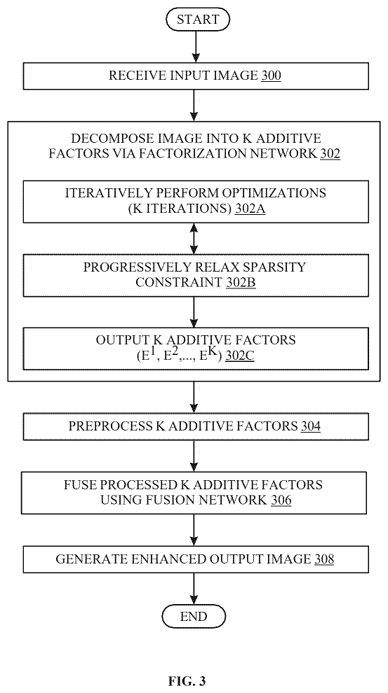

The disclosed method and system address limitations of existing techniques by enabling high-quality image enhancement through robust and interpretable image decomposition into meaningful additive factors. This approach offers effective performance in challenging conditions, such as low-light environments, demonstrates generalization across diverse datasets and degradation types, and provides the potential for zero-reference training for certain enhancement tasks. The disclosed techniques facilitate a lightweight, model-driven factorization network, support user-controllable image manipulation through the derived factors, and offer multi-task applicability, with performance often evaluated using metrics such as Peak Signal-to-Noise Ratio (PSNR), Structural Similarity Index Metric (SSIM), Naturalness Image Quality Evaluator (NIQE), and Learned Perceptual Image Patch Similarity (LPIPS). To make implementations of the present disclosure more comprehensible for a person skilled in the art, the following implementations are described with reference to the accompanying drawings, including FIG. 1 which illustrates an exemplary system block diagram overview for image enhancement, FIG. 2 which depicts a detailed block diagram of an exemplary factorization network architecture and its iterative process, and FIG. 3 which shows a flowchart of an exemplary method for image enhancement.

Terms such as “a first”, “a second”, “a third”, and “a fourth” (if any) in the summary, claims, and foregoing accompanying drawings of the present disclosure are used to distinguish between similar objects and are not necessarily used to describe a specific sequence or order. It should be understood that the terms so used are interchangeable under appropriate circumstances, so that the implementations of the present disclosure described herein are, for example, capable of being implemented in sequences other than the sequences illustrated or described herein. Furthermore, the terms “include” and “have” and any variations thereof, are intended to cover a non-exclusive inclusion; for example, a process, a method, a system, a product, or a device that includes a series of steps or units for image processing, is not necessarily limited to expressly listed steps or units but may include other steps or units that are not expressly listed or that are inherent to such process, method, product, or device.

The present disclosure provides a system and method for image enhancement, particularly by decomposing an image into multiple additive factors using a novel iterative specularity-based factorization approach, followed by fusing these factors to generate an enhanced image. The following description details one or more implementations of the present disclosure, and it should be understood that the present disclosure is not limited to the specific implementations described.

Referring now to FIG. 1, a block diagram illustrating an overview of an exemplary image enhancement system 100 is shown. The system 100 may include an Image Capturing Device 102, an optional Communication Network 104, and an Image Enhancement Server 106.

The Image Capturing Device 102 can be any device capable of acquiring images, such as a digital camera, smartphone camera, DSLR, or specialized imaging equipment. It captures an initial image and provides Raw/Input Image Data.

If the Image Capturing Device 102 is remote or separate from the Image Enhancement Server 106, the Raw/Input Image Data may be transmitted via a Communication Network 104. This network can be wired or wireless, such as the Internet, Wi-Fi, Bluetooth, or a local area network.

The Image Enhancement Server 106 is the central processing unit responsible for performing the image enhancement pipeline. The server 106 comprises a Processor 108 and Memory 110. The Memory 110 stores instructions that, when executed by the Processor 108, configure the server to perform the enhancement method. The Memory 110 also stores image data during processing.

Within the Image Enhancement Server 106, the image enhancement pipeline includes several functional stages executed by the Processor 108 using instructions from Memory 110: An Input Image Reception module (or process) 112 receives the Raw/Input Image Data, preparing it as the Input Image (I) for the subsequent stages. The Factorization Network 114 receives the Input Image (I) and decomposes it into a plurality of K additive factors (E¹, E², . . . , E^{K}). This network employs an iterative specularity/sparsity estimation process with progressive relaxation of constraints and utilizes learned parameters, as will be detailed further in relation to FIG. 2. An optional Factor Preprocessing stage 116 may then process these K additive factors, for example, by calculating difference factors (F^{k}=E^{k}−E^{k-1}). The Fusion Network 118 receives the K additive factors (or the processed factors from stage 116) and fuses them to generate an enhanced image. This network also performs enhancement and denoising operations and can utilize task-dependent architectures. An optional Post-Processing stage 120, such as applying a differentiable bilateral filter, can be used to further refine the image from the Fusion Network 118 for smoothness or artifact reduction. Finally, the Enhanced Output Image 122 is generated by the Image Enhancement Server 106.

FIG. 2 provides a more detailed block diagram depicting an exemplary architecture and iterative process of a Factorization Network 200, also referred to as an Iterative Decomposition Engine 204. The Factorization Network 200 receives an Input Image (I) 202.

The core of the Factorization Network 200 is an iterative process that executes K times to generate K additive factors. For the first iteration (k=1), the Input Image (I) 202 serves as the initial input X¹. A First Factorization Module (FM₁) 206 processes X¹. Internally, FM₁ 206 performs an Unrolled L₁ Optimization (typically over T inner iterations), estimates specularity or image highlights as sparsity, utilizes learned parameters specific for iteration 1 (e.g., thresholds, shrinkage values, step sizes), and operates under an initial, most stringent sparsity constraint (k=1). The output of FM₁ 206 is the first additive factor E¹.

The output E¹ and the input X¹ are then passed to a First Input Preparation Module 208. The First Input Preparation Module 208 calculates the input for the next stage, X²=X¹−E¹, and relaxes the sparsity constraint parameters for the subsequent Second Factorization Module (FM₂) 210.

The Second Factorization Module (FM₂) 210 then processes X², operating similarly to FM₁ 206 but with learned parameters for iteration 2 and a relaxed sparsity constraint (k=2). It outputs the second additive factor E². This output E² and input X² are fed to a Second Input Preparation Module 212, which calculates X³=X²−E² and further relaxes the sparsity constraint.

This sequence of a Factorization Module (FMₖ) followed by an Input Preparation Module continues for K iterations. The input to the Final (or k^{th}) Factorization Module is X^{k}. The Final Factorization Module (FMₖ) 214 processes X^{K} using learned parameters for iteration K and the most relaxed sparsity constraint (k=K) to produce the final additive factor E^{K}. The collected factors E¹, E², . . . , E^{K} form the Output: K Additive

### Factors 216 of the Factorization Network 200.

The Factorization Network, referred to as RSFNet, implements a novel recursive specularity factorization. The core idea is that an image X can be decomposed into a diffuse component A and a specular component E, such that X=A+E. The specular component E is estimated by minimizing an L₁ norm, which encourages sparsity, as given by the following Equation 1:

$${argmin}_{E , A} ‖ A ‖ * + λ {‖ E ‖}_{1}$$

$$s . t . X = A + E$$

where, X is the input image data, A is a diffuse term, E is a specular term, ∥A∥, is the Frobenius norm regularizer, ∥E∥₁ is the L₁ norm encouraging sparsity, and λ is a hyper parameter controlling the amount of sparsity.

Equation 1 can be solved using iterative ADMM (Alternating Direction Method of Multipliers) updates. For each iteration t (within a Factorization Module, up to T iterations), the updates are given by the following Equations 2(a), 2(b), and 2(c):

$${E}_{t + 1} = {δ}_{{α}_{t}}^{1} ( X - {A}_{t} - \frac{{Y}_{t}^{T}}{{μ}_{t}} )$$

$${A}_{t + 1} = {δ}_{{β}_{t}}^{*} ( X - {E}_{t + 1} - \frac{{Y}_{t}^{T}}{{μ}_{t}} )$$

$${Y}_{t + 1} = {Y}_{t} + {μ}_{t} ( {A}_{t + 1} + {E}_{t + 1} - X )$$

with αₜ (thresholds/shrinkage values), βₜ (thresholds/shrinkage values), and μₜ (step size) as learnable parameters, and

$${δ}_{α}^{p}$$

is an element-wise soft-thresholding operator defined as Equation 2(d):

$${δ}_{α}^{p} ( x ) = max ( 1 - \frac{α}{{\vert x \vert}_{p}} , 0 ) \cdot x .$$

This unrolling of optimization steps into network layers forms the Factorization Module (FM). Drawing parallels with LISTA, the update for E can also be represented as in Equation 3:

$${E}_{t + 1} = {δ}_{{α}_{t}} ( {w}_{t}^{1} {E}_{t} + {w}_{t}^{2} X )$$

with learnable parameters

$$( {α}_{t} , {w}_{t}^{1} , {w}_{t}^{2} ) .$$

Simplifications like ALISTA suggest that weight terms can be obtained analytically, leaving step sizes and thresholds to be learned.

For multiple factors (K factors), the process is applied recursively. After obtaining one specular factor E^{k}, the input X is updated, and the sparsity weight is relaxed. The initialization for each factor k (where X⁰=I, the input image) is given by the following Equations 4(a), 4(b), 4(c), and 4(d)

$${X}^{k + 1} = {X}^{k} - {E}^{k}$$

$${Y}_{o}^{k}$$

initialized (e.g., based on X^{k} as in Algorithm 1)

$$\begin{matrix}\begin{matrix}{α}^{k} = ( 1 - {ν}^{k} ) {\hat{X}}^{k} \\ {β}^{k} = {ν}^{k} {\hat{X}}^{k}\end{matrix} \\ {ν}^{k} = \frac{k}{K}\end{matrix}$$

where \hat{X}^{k} indicates the mean of X^{k}. This recursive application splits the original image I into K additive factors as per the following Equation 5:

$$I = {E}^{1} + {E}^{2} + … + {E}^{K} = {\sum }_{k = 1}^{K} {E}^{k}$$

The Factorization Network is trained using a novel factorization loss function L_{f}, given by the following Equation 6:

$${L}_{f} = {λ}_{f} {\sum }_{k = 1}^{K} {L}_{f}^{k}$$

where

$${L}_{f}^{k} = \vert \frac{{\hat{E}}^{k}}{{\hat{X}}^{k}} - {ν}^{k} \vert ,$$

constraining the signal energy ratio in the k^{th} factor to v^{k}, thereby gradually relaxing sparsity constraints to increase the number of pixels in the specular component. This loss constrains the ratio of signal energy in the k^{th} factor compared to its input, to v^{k}, and can enable zero-reference training. The Factorization Network is lightweight, requiring only about 3KT learnable scalar parameters for T unrolled optimization iterations and K factors.

After the K additive factors (E¹, E², . . . , E^{K}) are extracted, they are passed to a Fusion Network. As a pre-processing step, these factors E^{k} can be converted into difference factors F^{k} using the following Equation 7:

$${F}^{k} = {E}^{k} - {E}^{k - 1} , where {F}^{1} = {E}^{1}$$

These factors F^{k} (or original E^{k}) are then fed into the Fusion Network. The Fusion Network is typically a fully-convolutional architecture, potentially UNet-like with symmetric skip connections, adapted to handle multiple input factors. It simultaneously performs fusion, enhancement, and denoising. The fusion network may utilize task-dependent pre-existing architectures, adapting it for specific applications like low-light enhancement (LLE), deraining, dehazing, or deblurring.

The Fusion Network often outputs enhancement maps, such as gamma maps R^{k}, which are then used to adjust the original image I. One such adjustment mechanism is described by the following Equation 8:

$$O = Φ ( {\sum }_{k = 0}^{K} ( I + {R}^{k} \cdot ( {( I )}^{2} - I ) ) )$$

where O is the enhanced output and Φ represents a final processing step, such as a differentiable bilateral filtering layer, for smoothness and artifact reduction.

The Fusion Network is trained using a combination of loss terms. These typically include: A color loss L_{c}, based on the gray-world assumption, to minimize mean value differences between color channels:

$${L}_{c} = {\sum }_{( i , j ) ∈ C} {( - )}^{2} , C ∈ \{ ( r , g ) , ( g , b ) , ( b , r ) \}$$

An exposure loss Lₑ, penalizing grayscale intensity deviation from a mid-tone value (e.g., 0.6) over local windows:

$${L}_{e} = \frac{1}{\vert Ω \vert} {\sum }_{Ω} {( ϕ ( 0 ) - 0.6 )}^{2}$$

A pixel-wise smoothing loss L_s, controlling local gradients in the final output to reduce noise:

$${L}_{s} = \frac{1}{\vert Ω \vert} {\sum }_{Ω} ( {( {∇}_{x} O )}^{2} + {( {∇}_{y} O )}^{2} )$$

The final training loss for the fusion part, combined with the factorization loss if trained end-to-end or in stages, is given by the following Equation 9:

$$L = {λ}_{f} {L}_{f} + {λ}_{c} {L}_{c} + {λ}_{e} {L}_{e} + {λ}_{s} {L}_{s}$$

Where λ terms are respective loss weights.

The training process for the system, particularly for Low-Light Enhancement (LLE) can be summarized by the following Algorithm 1:

```
Input: Lowlight: I ; Hyperparams: λ_{c|e|s}, K, T
Output: Enhanced: O; Params: Θ= {α}^{K}₀ , {β}^{K}₀ , {μ}^{K}₀
  for e ← 0 to num of epochs do
|| Train factorization module
  for k ← 0 to K do
    for t ← 0 to T do
      Initialize E^{k}_{0,} A^{k}_{0,} Y^{k}_{0,};
      E_{t,} A_{t,} Yₜ ADMM updates;
    end
    F^{k} ← E^{k} − E^{k-1};
  end
  compute L_{f} :
  // Train fusion Module
  if e > freeze epoch then
Freeze all α, β, μ;
L_{f} ← 0;
end
I_{fuse} ← concatenate [I, F¹,...., F^{K}];
O ← Forward (I_{fuse});
Compute L;
Backpropagation L;
end;
```

This algorithm outlines how the factorization and fusion networks can be trained, potentially in stages, to learn the optimal parameters for decomposition and subsequent enhancement.

FIG. 3 is a flowchart illustrating the steps of an exemplary method 300 for image enhancement according to the present disclosure. The method begins at step Receive Input Image 300, where an image is provided to the system. Next, at step Decompose Image into K Additive Factors via Factorization Network 302, the input image is processed by the Factorization Network as detailed in FIG. 2 and the accompanying technical formulation. This decomposition involves sub-steps: Iteratively Perform Optimizations (K iterations) 302A, where each factor is estimated using an L₁ optimization process with learned parameters; Progressively Relax Sparsity Constraint 302B, where the sparsity constraint is made less stringent for each successive factor estimation; leading to the Output K Additive Factors (E¹, E², . . . , E^{K}) 302C. Optionally, at step Preprocess K Additive Factors 304, these factors may be transformed, for instance, into difference factors (F^{k}). Then, at step Fuse Processed K Additive Factors using Fusion Network 306, the K additive factors (or their preprocessed versions) are combined, enhanced, and denoised by the Fusion Network. Finally, at step Generate Enhanced Output Image 308, the processed output from the Fusion Network is provided as the final enhanced image. The method then ends.

The described system and method provide a robust and flexible approach to image enhancement by effectively separating an image into meaningful components and then intelligently fusing them for various enhancement tasks. The model-driven nature of the factorization, combined with learned parameters and specific loss functions, allows for high-quality results, efficient processing, and applicability even in zero-reference scenarios.

To demonstrate the efficacy and characteristics of the present disclosure, various experiments were conducted. The following body of text summarizes these experimental aspects and results.

The combined network, comprising the Factorization Network and the Fusion Network, was implemented end-to-end in PyTorch and executed on a single Nvidia 1080Ti GPU. Low-light RGB images were used directly as inputs without additional pre-processing. The training strategy involved first training the Factorization Network for a set number of epochs (e.g., 25 epochs), then freezing its parameters and subsequently optimizing the Fusion Network for another set number of epochs (e.g., 25 epochs). Stochastic gradient descent was employed for optimization, typically with a batch size of 10 and a learning rate of 0.01. Model hyperparameters were determined using grid search, and the entire training process was noted to be efficient, for instance, taking less than 30 minutes.

The performance of the described method was evaluated using multiple standard Low-Light Enhancement (LLE) benchmark datasets, including Lolv1, Lolv2-real, Lolv2-synthetic, and VE-Lol, using their standard train/test splits. For generalization assessment on images without ground truth, additional no-reference datasets such as DICM, LIME, MEF, NPE, and VV were utilized.

Evaluation metrics included full-reference metrics (requiring ground truth): Peak Signal-to-Noise Ratio (PSNR), Structural Similarity Index Metric (SSIM), and Learned Perceptual Image Patch Similarity (LPIPS). For no-reference assessment, Naturalness Image Quality Evaluator (NIQE) and Lightness Order Error (LOE) were reported. Both single-channel (Y from YCbCr) and multichannel (RGB) performance scores were considered.

The method of the present disclosure was compared against several traditional model-based optimization methods (e.g., LIME, DUAL, SDD) and multiple recent zero-reference data-driven methods (e.g., ECNet, zeroDCE, zeroDCE++, RUAS, SCI, PNet, GDP).

Quantitative comparisons for Low-Light Enhancement (LLE) on standard benchmarks are detailed in Table 1.

Table: 1 illustrates a quantitative comparison of the disclosed image enhancement method (RSFNet) against other traditional and zero-reference solutions on multiple low-light benchmarks, showcasing performance across various evaluation metrics such as PSNR, SSIM, NIQE, and LPIPS, including parameter counts.

TABLE 1

| | PARADIGM | | | | | | | | | | |
|---|---|---|---|---|---|---|---|---|---|---|---|
| | TRADITIONAL | | | | | | | | | | |
| | MODEL BASED | | | ZERO-REFERENCE | | | | | | | |
| | METHOD | | | | | | | | | | |
| | | | | | | | | | | | RSFNET |
| | LIME | DUAL | SDD | ECNET | ZDCE | ZD++ | RUAS | SCI | PNET | GDP | (OURS) |
| PARAMS ×10³ | — | — | — | 16.5*10³ | 79.42 | 10.56 | 3.43 | 0.26 | 15.25 | 552*10³ | 2.11 |

LOLV1 (DATASET SPLIT: 689/100~0.05, RESOLUTION: 400 * 600)

| | | | | | | | | | | | |
|---|---|---|---|---|---|---|---|---|---|---|---|
| PSNRYN | 16.20 | 15.97 | 15.14 | 18.01 | 16.76 | 16.38 | 18.45 | 16.45 | 19.85 | 17.68 | 22.17 |
| SSIMA | 0.695 | 0.692 | 0.754 | 0.644 | 0.734 | 0.645 | 0.766 | 0.709 | 0.718 | 0.678 | 0.860 |
| PSNRA | 14.22 | 14.02 | 13.34 | 15.81 | 14.86 | 14.74 | 16.40 | 14.78 | 17.50 | 15.80 | 19.39 |
| SSIMA | 0.521 | 0.519 | 0.634 | 0.469 | 0.562 | 0.496 | 0.503 | 0.525 | 0.550 | 0.539 | 0.755 |
| NIQE | 8.583 | 8.611 | 3.706 | 8.844 | 8.223 | 8.195 | 5.927 | 8.374 | 8.629 | 6.437 | 3.129 |
| LPIPS | 0.344 | 0.346 | 0.278 | 0.358 | 0.331 | 0.346 | 0.303 | 0.327 | 0.340 | 0.375 | 0.265 |

LOLV2-REAL (DATASET SPLIT: 689/100 ≈ 0.05, RESOLUTION: 400 * 600)

| | | | | | | | | | | | |
|---|---|---|---|---|---|---|---|---|---|---|---|
| PSNRA | 19.31 | 19.10 | 18.47 | 18.86 | 20.31 | 19.36 | 17.49 | 19.37 | 20.08 | 15.83 | 21.46 |
| SSIMA | 0.705 | 0.704 | 0.792 | 0.613 | 0.745 | 0.585 | 0.742 | 0.722 | 0.691 | 0.627 | 0.836 |
| PSNRA | 17.14 | 16.95 | 16.64 | 16.27 | 18.06 | 17.36 | 15.33 | 17.30 | 17.63 | 14.05 | 19.27 |
| SSIMA | 0.537 | 0.535 | 0.678 | 0.459 | 0.580 | 0.442 | 0.493 | 0.540 | 0.539 | 0.502 | 0.738 |
| NIQEY | 9.076 | 9.083 | 4.191 | 9.475 | 4.191 | 8.709 | 6.172 | 8.739 | 9.152 | 6.867 | 3.769 |
| LPIPSY | 0.322 | 0.324 | 0.280 | 0.360 | 0.310 | 0.340 | 0.325 | 0.294 | 0.340 | 0.390 | 0.280 |

GENERALIZED PERFORMANCE

| | | | | | | | | | | | |
|---|---|---|---|---|---|---|---|---|---|---|---|
| PSNRA | 18.50 | 17.83 | 17.50 | 18.45 | 19.26 | 18.73 | 17.09 | 18.07 | 19.65 | 15.88 | 21.16 |
| SSIMA | 0.737 | 0.728 | 0.781 | 0.677 | 0.777 | 0.674 | 0.743 | 0.745 | 0.743 | 0.634 | 0.854 |
| PSNRA | 16.53 | 15.88 | 15.77 | 16.25 | 17.19 | 16.76 | 15.12 | 16.20 | 17.35 | 14.15 | 18.45 |
| SSIM | 0.596 | 0.583 | 0.679 | 0.538 | 0.634 | 0.548 | 0.532 | 0.587 | 0.605 | 0.504 | 0.758 |
| NIQEY | 7.855 | 7.478 | 4.077 | 7.543 | 4.270 | 7.468 | 5.841 | 5.841 | 7.791 | 6.726 | 3.763 |
| LPIPSY | 0.291 | 0.297 | 0.266 | 0.329 | 0.273 | 0.296 | 0.346 | 0.346 | 0.302 | 0.379 | 0.276 |

LOLV1 (DATASET SPLIT: 689/100 ≈ 0.05, RESOLUTION: 400 * 600)

| | | | | | | | | | | | |
|---|---|---|---|---|---|---|---|---|---|---|---|
| PSNRY | 16.20 | 15.97 | 15.14 | 18.01 | 16.76 | 16.38 | 18.45 | 16.45 | 19.85 | 17.68 | 22.17 |
| SSIMA | 0.695 | 0.692 | 0.754 | 0.644 | 0.734 | 0.645 | 0.766 | 0.709 | 0.718 | 0.678 | 0.860 |
| PSNRA | 14.22 | 14.02 | 13.34 | 15.81 | 14.86 | 14.74 | 16.40 | 14.78 | 17.50 | 15.80 | 19.39 |
| SSIMA | 0.521 | 0.519 | 0.634 | 0.469 | 0.562 | 0.496 | 0.503 | 0.525 | 0.550 | 0.539 | 0.755 |
| NIQE | 8.583 | 8.611 | 3.706 | 8.844 | 8.223 | 8.195 | 5.927 | 8.374 | 8.629 | 6.437 | 3.129 |
| LPIPSV | 0.344 | 0.346 | 0.278 | 0.358 | 0.331 | 0.346 | 0.303 | 0.327 | 0.340 | 0.375 | 0.265 |

LOLV2-REAL (DATASET SPLIT: 689/100 ≈ 0.05, RESOLUTION: 400 * 600)

| | | | | | | | | | | | |
|---|---|---|---|---|---|---|---|---|---|---|---|
| PSNRA | 19.31 | 19.10 | 18.47 | 18.86 | 20.31 | 19.36 | 17.49 | 19.37 | 20.08 | 15.83 | 21.46 |
| SSIMA | 0.705 | 0.704 | 0.792 | 0.613 | 0.745 | 0.585 | 0.742 | 0.722 | 0.691 | 0.627 | 0.836 |
| PSNRA | 17.14 | 16.95 | 16.64 | 16.27 | 18.06 | 17.36 | 15.33 | 17.30 | 17.63 | 14.05 | 19.27 |
| SSIMA | 0.537 | 0.535 | 0.678 | 0.459 | 0.580 | 0.442 | 0.493 | 0.540 | 0.539 | 0.502 | 0.738 |
| NIQEV | 9.076 | 9.083 | 4.191 | 9.475 | 4.191 | 8.709 | 6.172 | 8.739 | 9.152 | 6.867 | 3.769 |
| LPIPSY | 0.322 | 0.324 | 0.280 | 0.360 | 0.310 | 0.340 | 0.325 | 0.294 | 0.340 | 0.390 | 0.280 |

GENERALIZED PERFORMANCE

| | | | | | | | | | | | |
|---|---|---|---|---|---|---|---|---|---|---|---|
| PSNRA | 18.50 | 17.83 | 17.50 | 18.45 | 19.26 | 18.73 | 17.09 | 18.07 | 19.65 | 15.88 | 21.16 |
| SSIMA | 0.737 | 0.728 | 0.781 | 0.677 | 0.777 | 0.674 | 0.743 | 0.745 | 0.743 | 0.634 | 0.854 |
| PSNRA | 16.53 | 15.88 | 15.77 | 16.25 | 17.19 | 16.76 | 15.12 | 16.20 | 17.35 | 14.15 | 18.45 |
| SSIMA | 0.596 | 0.583 | 0.679 | 0.538 | 0.634 | 0.548 | 0.532 | 0.587 | 0.605 | 0.504 | 0.758 |
| NIQE | 7.855 | 7.478 | 4.077 | 7.543 | 4.270 | 7.468 | 5.841 | 5.841 | 7.791 | 6.726 | 3.763 |
| LPIPSY | 0.291 | 0.297 | 0.266 | 0.329 | 0.273 | 0.296 | 0.346 | 0.346 | 0.302 | 0.379 | 0.276 |

This table typically presents performance scores across various metrics such as PSNR (Y channel and RGB), SSIM (Y channel and RGB), NIQE, and LPIPS on datasets like LOLv1 and LOLv2-real. The results in Table 1 show the method of the present disclosure (RSFNet) achieving competitive or superior performance against other traditional and zero-reference solutions, often marking the best or second-best scores across multiple metrics and datasets, including a mean score across all datasets presented in a sub-table within it. For instance, on the LOLv1 dataset, RSFNet is shown to significantly outperform other methods in PSNR and SSIM, while also achieving the best NIQE and LPIPS scores. Similar strong performance is reported for the LOLv2-real dataset and in terms of generalized performance (mean scores across multiple datasets). Table 1 also highlights the parameter count of different methods, showing RSFNet to be relatively lightweight compared to some other deep learning models while achieving strong results.

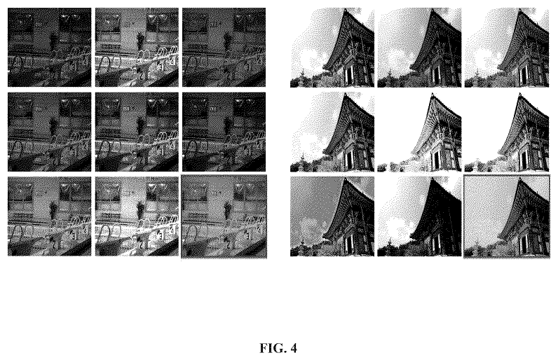

Qualitative comparisons, such as those presented in FIG. 4, further demonstrate that the output of the described method tends to be cleaner, with fewer artifacts and more natural illumination compared to other solutions. FIG. 4 typically shows side-by-side visual results on example images from various methods, where the method of the present disclosure (RSFNet) handles noisy over and under-exposed regions well without over-saturating color or losing geometric details.

The perceptual quality is further supported by metrics like NIQE, LPIPS, and LOE. For instance, Table 2 presents a quantitative comparison using naturalness preserving metrics (NIQE and LOE) on five no-reference benchmarks (DICM, LIME, MEF, NPE, and VV), where the described method (RSFNet) shows competitive or superior performance in terms of lower NIQE and LOE scores, indicating better naturalness and lightness order preservation.

Table: 2 illustrates a qualitative comparison using naturalness preserving metrics (NIQE and LOE) on five no-reference benchmark datasets, comparing the disclosed method with other zero-reference solutions

TABLE 2

| NIQE | | | | | | | RSFNET |
|---|---|---|---|---|---|---|---|
| & LOE | ECNET | ZDCE | ZD++ | RUAS | PNET | SCI | (OURS) |
| DICM | 3.37-676.7 | 3.10-340.8 | 2.94-511.9 | 4.89-1421 | 3.00-590.3 | 3.61-321.9 | 3.23-303.1 |
| LIME | 3.75-685.1 | 3.79-135.0 | 3.89-332.2 | 4.26-719.9 | 3.84-223.2 | 4.14-75.5 | 3.80-68.3 |
| MEF | 3.30-863.3 | 3.31-164.3 | 3.18-458.5 | 4.08-784.2 | 3.25-363.0 | 3.43-95.0 | 3.00-100.7 |
| NPE | 3.24-936.1 | 3.52-312.9 | 3.27-532.2 | 5.75-1399 | 3.29-601.1 | 3.89-239.8 | 3.31-221.5 |
| VV | 2.15-292.4 | 2.75-145.4 | 2.53-222.9 | 3.82-583.7 | 2.56-260.2 | 2.30-109.0 | 1.96-109.0 |
| MEAN | 3.16-690.7 | 3.29-219.7 | 3.16-411.5 | 4.56-981.7 | 3.19-407.5 | 3.47-168.2 | 3.06-160.5 |

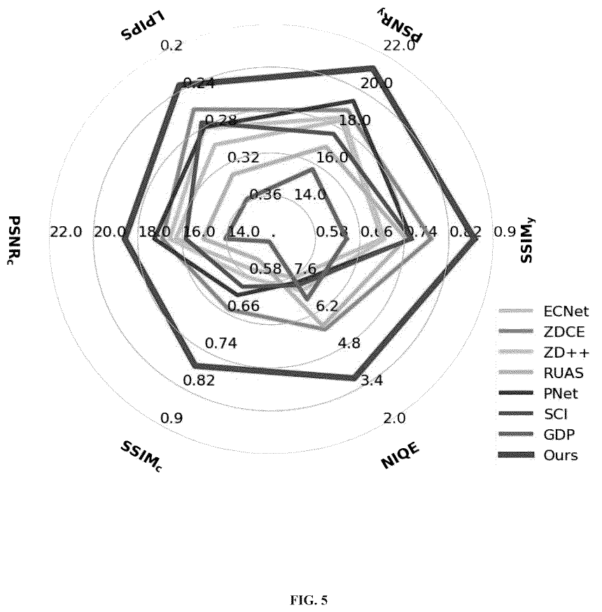

A generalized performance summary across multiple datasets and metrics is graphically presented in the polar plot in FIG. 5. In such a plot, each polygon represents a separate LLE method, and a larger area inside the polygon typically indicates better overall performance across the displayed metrics. The method of the present disclosure (RSFNet) is shown to achieve a favorable area, indicating strong average performance.

To validate design choices, ablation studies were conducted as described in the following body of text.

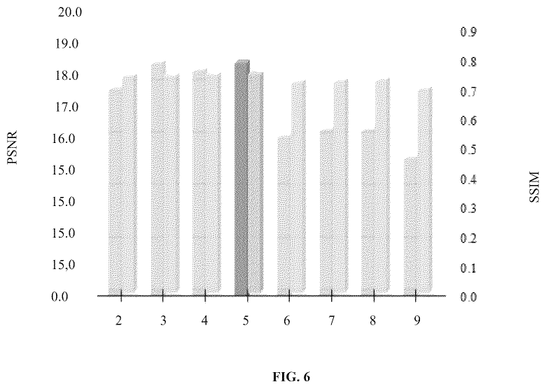

The effect of varying the number of factors K on final PSNR and SSIM scores was analyzed, with results shown, for example, in FIG. 6. Based on such analysis, an optimal K (e.g., K=5) was chosen for experiments.

The impact of different loss terms (e.g., L_{c}, Lₑ, Lₛ) and the final denoising step (e.g., bilateral filter) was also evaluated, with quantitative results typically presented in a tabular format, such as that shown in Table 3.

Table: 3 illustrates an ablation analysis on variants of the disclosed method, detailing the effect of removing different loss components or the fusion network on performance metrics for a specific dataset; and

TABLE 3

| VARIANTS | PSNR_{Y} [symbol] | SSIM_{Y} [symbol] |
|---|---|---|
| W/0 L_{E} | 8.12 | 0.238 |
| W/O L_{C} | 16.05 | 0.724 |
| W/O L_{S} | 20.13 | 0.846 |
| W/O DENOISE | 19.51 | 0.756 |
| W/O FUSION | 19.32 | 0.830 |
| FULL | 22.17 | 0.860 |

Table 3 illustrates how removing specific loss components or the denoising step affects metrics like PSNR and SSIM, thereby justifying their inclusion. An interesting setting, “w/o Fusion,” where the fusion network is removed and inference uses only a minimal set of parameters (e.g., 3KT parameters, such as 45 parameters if K=5 and T=3), was also evaluated. Even in such a simplified setup with linear fusion, the method demonstrated good performance, highlighting the effectiveness of the generated factors.

The utility of the specular factors generated by the Factorization Network extends beyond LLE. These factors can serve as a pre-processing step or a structural prior for other image enhancement tasks when combined with suitable base models.

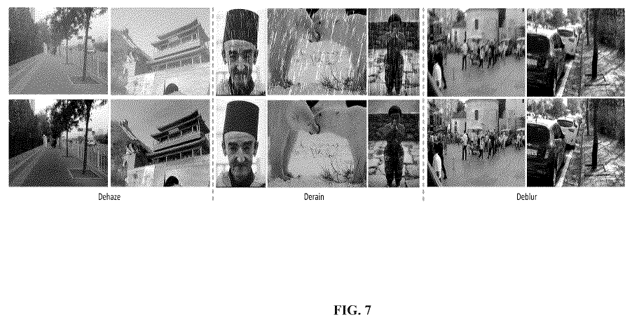

Experiments were conducted using AirNet as a base model, modified to accept the generated factors concatenated with the original input. The system was trained for tasks including Dehazing (e.g., on RESIDE dataset), Deraining (e.g., on Rain 100L dataset), and Deblurring (e.g., on GoPro dataset). Qualitative results for these tasks are shown in FIG. 7, demonstrating perceptually pleasing outputs. Quantitative improvements over baseline methods (e.g., AirNet multi-task or uni-task) in terms of PSNR and SSIM are presented in Table 4.

Table: 4 illustrates the improvement in performance (PSNR and SSIM) when the disclosed specular factors are used as an input prior to an existing base model (AirNet) for multiple image enhancement tasks, namely dehazing, deraining, and deblurring, on respective benchmark datasets.

TABLE 4

| TASK | DEHAZE | | DERAIN | | DEBLUR | |
|---|---|---|---|---|---|---|
| METHOD | PSNR | SSIM | PSNR | SSIM | PSNR | SSIM |
| AIRNET | 21.04 | 0.884 | 32.98 | 0.951 | 24.35 | 0.781 |
| (MULTITASK) | | | | | | |
| AIRNET | 23.18 | 0.900 | 34.90 | 0.9657 | 26.42 | 0.801 |
| (UNI TASK) | | | | | | |
| AIRNET + | 24.96 | 0.9292 | 36.19 | 0.9718 | 27.29 | 0.827 |
| OURS | | | | | | |

These results suggest that the factors provide valuable structural information, improving performance on these diverse tasks.

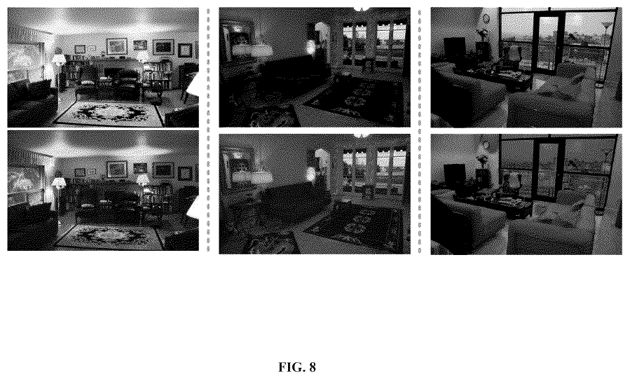

The generated specular factors are interpretable and can be directly used for image manipulation, such as controllable relighting. By treating the factors as image layers in standard image editing software, users can vary their color and blending modes to achieve desired relighting effects. Examples of such applications, including editing light specularity, indoor color, and outdoor intensity, are illustrated in FIG. 8.

The described method can be sensitive to initialization conditions, a common characteristic of algorithms involving unrolled optimization. As a heuristic, dataset mean can be used for initialization. Future explorations may involve dynamic adaptation to each input to potentially further enhance performance.

The present disclosure describes a recursive specularity factorization (RSF) approach and its application to image enhancement, with a particular focus demonstrated for zero-reference Low-Light Enhancement (LLE). The core of the factorization involves learning optimization hyperparameters in a data-driven fashion by unrolling the optimization stages into a compact neural network (Factorization Network or RSFNet). The resulting factors, which represent different illumination characteristics, are then fused, potentially using another task-specific network (Fusion Network), to yield the final enhanced image.

The utility of the generated RSF factors is further demonstrated by their applicability to direct image relighting and as effective priors for other image enhancement tasks such as dehazing, deraining, and deblurring when integrated with existing architectures. The method is designed to be lightweight, interpretable, and generalizable.

Potential future extensions of the RSF approach include its application to other computer vision tasks like image harmonization, foreground matting, white-balancing, depth estimation, and extending the technique to signals beyond the visible spectrum, such as hyperspectral images or LiDAR scans. The methods and systems described aim to enhance captured images and do not pose special ethical concerns beyond those generally applicable to image processing technologies.

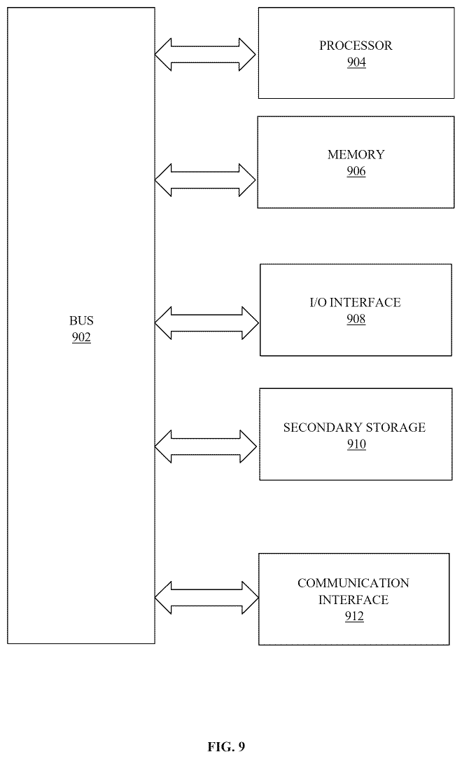

FIG. 9 is an illustration of a computer system in which the various architectures and functionalities of the various previous implementations may be implemented. As shown, the computer system 900 includes at least one processor 904 that is connected to a bus 902, wherein the computer system 900 may be implemented using any suitable protocol, such as PCI (Peripheral Component Interconnect), PCI-Express, AGP (Accelerated Graphics Port), Hyper Transport, or any other bus or point-to-point communication protocol(s). The computer system 900 also includes a memory 906.

Control logic (software) and data are stored in the memory 906 which may take a form of random-access memory (RAM). In the disclosure, a single semiconductor platform may refer to a sole unitary semiconductor-based integrated circuit or chip. It should be noted that the term single semiconductor platform may also refer to multi-chip modules with increased connectivity which simulate on-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The computer system 900 may also include a secondary storage 910. The secondary storage 910 includes, for example, a hard disk drive and a removable storage drive, representing a floppy disk drive, a magnetic tape drive, a compact disk drive, digital versatile disk (DVD) drive, recording device, universal serial bus (USB) flash memory. The removable storage drive at least one of reads from and writes to a removable storage unit in a well-known manner.

Computer programs, or computer control logic algorithms, may be stored in at least one of the memories 906 and the secondary storage 910. Such computer programs, when executed, enable the computer system 900 to perform various functions as described in the foregoing. The memory 906, the secondary storage 910, and any other storage are possible examples of computer-readable media.

In an implementation, the architectures and functionalities depicted in the various previous figures may be implemented in the context of the processor 904, a graphics processor coupled to a communication interface 912, an integrated circuit (not shown) that is capable of at least a portion of the capabilities of both the processor 904 and a graphics processor, a chipset (namely, a group of integrated circuits designed to work and sold as a unit for performing related functions, and so forth).

Furthermore, the architectures and functionalities depicted in the various previous-described figures may be implemented in a context of a general computer system, a circuit board system, a game console system dedicated for entertainment purposes, an application-specific system. For example, the computer system 900 may take the form of a desktop computer, a laptop computer, a server, a workstation, a game console, an embedded system.

Furthermore, the computer system 900 may take the form of various other devices including, but not limited to a personal digital assistant (PDA) device, a mobile phone device, a smart phone, a television, and so forth. Additionally, although not shown, the computer system 900 may be coupled to a network (for example, a telecommunications network, a local area network (LAN), a wireless network, a wide area network (WAN) such as the Internet, a peer-to-peer network, a cable network, or the like) for communication purposes through an I/O interface 908.

It should be understood that the arrangement of components illustrated in the figures described is exemplary and that other arrangements may be possible. It should also be understood that the various system components (and means) defined by the claims, described below, and illustrated in the various block diagrams represent components in some systems configured according to the subject matter disclosed herein.

For example, one or more of these system components (and means) may be realized, in whole or in part, by at least some of the components illustrated in the arrangements illustrated in the described figures.

In addition, while at least one of these components are implemented at least partially as an electronic hardware component, and therefore constitutes a machine, the other components may be implemented in software that when included in an execution environment constitutes a machine, hardware, or a combination of software and hardware.

Although the disclosure and its advantages have been described in detail, it should be understood that various changes, substitutions, and alterations can be made herein without departing from the spirit and scope of the disclosure as defined by the appended claims.

What is claimed is:

1. A processor-implemented method for enhancing light in an image using a recursive factorization network and a fusion network, the method comprising:
receiving, by the recursive factorization network, an input image as a first input from an image-capturing device;
decomposing, via the recursive factorization network comprising a sequence of K iterative factorizations, the input image into a plurality of K additive factors, wherein the decomposing comprises:
(i) performing an optimization process, at a first K iteration, to apply an unrolled L₁ optimization on the first input over T inner iterations, to approximate estimate a first additive factor comprising an image specularity or highlights as matrix sparsity using learned parameters that are specific to the first K iteration;
(ii) computing a second input by subtracting the first input from the first additive factor, wherein the second input corresponds to the input image with a reduced sparsity constraint;
(iii) performing the optimization process, at a second K iteration, to apply the unrolled L₁ optimization on the second input over T inner iterations, to estimate a second additive factor comprising an image specularity or highlights as matrix sparsity using learned parameters that are specific to the second K iteration; and
(iv) progressively reducing the sparsity constraint associated with the input image for each consecutive iteration to enable the extraction of increasingly less sparse additive factors;
processing the plurality of K additive factors using the fusion network to generate a plurality of enhancement maps configured to adjust pixel intensities in the input image; and
generating an enhanced output image by applying the plurality of enhancement maps to the input image using a differentiable bilateral filtering layer for smoothness and artifact reduction.

2. The method of claim 1, wherein the recursive factorization network comprises a plurality of network layers that are trained by unrolling the steps of the optimization process into the network layers using hyperparameters.

3. The method of claim 1, wherein the recursive factorization network is trained using a factorization loss function to enable the decomposition of the first input into the plurality of K additive factors, wherein the factorization loss function constrains a ratio of signal energy in each k^{th} additive factor, and the corresponding input for that k^{th} factor iteration to a predetermined value v^{k}, thereby gradually reducing the sparsity constraints to increase a number of pixels in a specular component of the plurality of K additive factors.

4. The method of claim 3, wherein the factorization loss function enables zero-reference training of the recursive factorization network.

5. The method of claim 1, wherein progressively reducing the sparsity constraint comprises adjusting the hyperparameter of the recursive factorization network that controls an amount of the sparsity in a solution of the unrolled L₁ optimization for each of the K iterations.

6. The method of claim 1, wherein the fusion network is trained using at least one of color constancy loss, an exposure loss, or pixel-wise smoothing loss to enhance and denoise the plurality of K additive factors.

7. The method of claim 1, wherein the fusion network utilizes a task-dependent pre-existing network architecture adapted for a specific image enhancement task selected from the group consisting of low-light enhancement, deraining, dehazing, and deblurring.

8. The method of claim 1, wherein the learned parameters for each k iteration comprises at least one of threshold, shrinkage values and step size for each of the T inner iterations within the unrolled L₁ optimization.

9. A system for enhancing light in an image using a recursive factorization network and a fusion network, the system comprising:
a processor; and
a memory storing instructions that, when executed by the processor, configure the system to:
receive, by the recursive factorization network, an input image as a first input from an image-capturing device;
decompose, via the recursive factorization network comprising a sequence of K iterative factorizations, the input image into a plurality of K additive factors by:
a. performing an optimization process, at a first K iteration, to apply an unrolled L₁ optimization on the first input over T inner iterations, to estimate a first additive factor comprising an image specularity or highlights as matrix sparsity using learned parameters that are specific to the first K iteration;
b. computing a second input by subtracting the first input from the first additive factor, wherein the second input corresponds to the input image with a reduced sparsity constraint;
c. performing the optimization process, at a second K iteration, to apply the unrolled L₁ optimization on the second input over T inner iterations, to estimate a second additive factor comprising an image specularity or highlights as matrix sparsity using learned parameters that are specific to the second K iteration; and
d. progressively reducing the sparsity constraint associated with the input image for each consecutive iteration to enable the extraction of increasingly less sparse additive factors;
process the plurality of K additive factors using the fusion network to generate a plurality of enhancement maps configured to adjust pixel intensities in the input image; and
generate an enhanced output image by applying the plurality of enhancement maps to the input image using a differentiable bilateral filtering layer for smoothness and artifact reduction.

10. The system of claim 9, wherein the recursive factorization network comprises a plurality of network layers that are trained by unrolling the steps of the optimization process into the network layers using hyperparameters.

11. The system of claim 9, wherein the instructions further configure the recursive factorization network to be trainable using a factorization loss function to enable the decomposition of the first input into the plurality of K additive factors, wherein the factorization loss function constrains a ratio of signal energy in each k^{th} additive factor and the corresponding input for that k^{th} factor iteration to a predetermined value v^{k}, thereby gradually reducing the sparsity constraints to increase a number of pixels in a specular component of the plurality of K additive factors.

12. The system of claim 11, wherein the factorization loss function enables zero-reference training of the recursive factorization network.

13. The system of claim 9, wherein the recursive factorization network is configured such that progressively reducing the sparsity constraint comprises adjusting the hyperparameter of the recursive factorization network that controls an amount of the sparsity in a solution of the unrolled L₁ optimization for each of the K iterations.

14. The system of claim 9, wherein the fusion network is trained using at least one of color constancy loss, an exposure loss, or pixel-wise smoothing loss to enhance and denoise the plurality of K additive factors.

15. The system of claim 9, wherein the fusion network utilizes a task-dependent pre-existing network architecture adapted for a specific image enhancement task selected from the group consisting of low-light enhancement, deraining, dehazing, and deblurring.

16. The system of claim 9, wherein the learned parameters for each k iteration comprises at least one of threshold, shrinkage values and step size for each of the T inner iterations within the unrolled L₁ optimization.

17. (canceled)
